(19) United States
(12) Patent Application Publication
(10) Pub. No.: US 2019/0057192 A1
(43) Pub. Date: Feb. 21, 2019

(54) ELECTRONIC DATA INSPECTION SYSTEM, ELECTRONIC DATA INSPECTION METHOD AND STORAGE MEDIUM IN WHICH ELECTRONIC DATA INSPECTION PROGRAM IS STORED

(71) Applicant: NEC Corporation, Tokyo (JP)

(72) Inventor: Yuki YOSHIMURA, Tokyo (JP)

(73) Assignee: NEC Corporation, Tokyo (JP)

(21) Appl. No.: 16/078,227

(22) PCT Filed: Mar. 9, 2017
(86) PCT No.: PCT/JP2017/009395

§ 371 Date: Aug. 21, 2018

(30) Foreign Application Priority Data
Mar. 15, 2016 (JP) 2016-051052

(51) Int. Cl. G06F 21/10; G06F 17/30

(52) U.S. Cl. CPC G06F 21/10; G06F 2221/0737; G06F 17/30371

(57) ABSTRACT

An electronic data inspection system capable of appropriately inspecting electronic data is provided. A first determination unit determines whether electronic data is illegally posted or not. A second determination unit determines whether the electronic data determined to be illegally posted by the first determination unit is illegally posted or not, with higher accuracy than the first determination unit. If the first determination unit or the second determination unit determines that the electronic data is not illegally posted, a registration unit deliverably stores the electronic data in a storage means. According to the number of pieces of electronic data that are determined to be illegally posted by the first determination unit and are waiting for determination by the second determination unit, a control unit causes the first determination unit to sequentially perform determination processing of other pieces of posted electronic data prior to the determination processing of electronic data by the second determination unit.

### TECHNICAL FIELD

The present invention relates to an electronic data inspection system, an electronic data inspection method, and an electronic data inspection program that inspect electronic data.

### BACKGROUND ART

There is a video delivery service that delivers video data through a communication network such as the Internet. In such a service, a provider of video data, for example, registers video data on a video delivery server installed by a video delivery service provider through a communication network by operating a communication terminal such as a smartphone or a personal computer.

Then, a viewer retrieves the video data registered on the video delivery server through the communication network by operating a communication terminal such as a smartphone or a personal computer and views a video according to the video data.

PTL 1 describes a system that censors posted video data.

### CITATION LIST

### Patent Literature

### [PTL 1] Japanese Unexamined Patent Application Publication No. 2009-89440

### SUMMARY OF INVENTION

### Technical Problem

The system described in PTL 1 is configured to censor posted video data before the video data is made accessible or after the video data is made accessible.

However, when video data is censored before the video data is made accessible, there is a problem that censorship processing of many pieces of video data need to be quickly performed. Further, when video data is censored after the video data is made accessible, there is a problem that problematic video data may be delivered until completion of censorship processing.

Therefore, the system described in PTL 1 has a problem that inspection of posted video data is not appropriately performed.

Therefore, an object of the present invention is to provide an electronic data inspection system, an electronic data inspection method, and an electronic data inspection program that are capable of appropriately inspecting electronic data.

### Solution to Problem

An electronic data inspection system according to the present invention includes: first determination means for determining whether or not electronic data is illegally posted electronic data; second determination means for determining whether or not the electronic data determined to be illegally posted electronic data by the first determination means is illegally posted electronic data, with higher accuracy than the first determination means; registration means for storing the electronic data into storage means in a deliverable manner when the first determination means or the second determination means determines that the electronic data is not illegally posted electronic data; and control means for causing the first determination means, prior to determination processing for the electronic data by the second determination means, to perform determination processing for other pieces of posted electronic data in order, depending on a number of pieces of electronic data that are determined by the first determination means to be illegally posted and wait for determination by the second determination means.

An electronic data inspection method according to the present invention includes: making first determination whether or not electronic data is illegally posted electronic data; making second determination whether or not the electronic data determined to be illegally posted electronic data in the first determination is illegally posted electronic data, with higher accuracy than the first determination; storing the electronic data in storage means in a deliverable manner when the electronic data is determined not to be illegally posted electronic data in the first determination or the second determination; and prior to determination processing for the electronic data by the second determination, causing determination processing for other pieces of posted electronic data to be performed in order in the first determination, depending on a number of pieces of electronic data that are determined to be illegally posted in the first determination and wait for determination by the second determination.

An electronic data inspection program according to the present invention causes a computer to execute: first determination processing of determining whether or not electronic data is illegally posted electronic data; second determination processing of determining whether or not the electronic data determined to be illegally posted electronic data in the first determination processing is illegally posted electronic data, with higher accuracy than the first determination processing; and registration processing of storing the electronic data in storage means in a deliverable manner when the electronic data is determined not to be illegally posted electronic data in the first determination processing or the second determination processing, and to perform, prior to the second determination processing for the electronic data, the first determination processing for pieces of other posted electronic data in order, depending on a number of pieces of electronic data that are determined to be illegally posted in the first determination processing and wait for determination by the second determination processing.

### Advantageous Effects of Invention

According to the present invention, electronic data can be appropriately inspected.

### BRIEF DESCRIPTION OF DRAWINGS

FIG. 1 is a block diagram illustrating a configuration example of a video data inspection system of a first example embodiment of the present invention.

FIG. 2 is a flowchart illustrating an operation of the video data inspection system of the first example embodiment of the present invention for generating search data.

FIG. 3 is a flowchart illustrating an operation of a video data inspection system when the video data inspection system has received video data sent by a video provider terminal device.

FIG. 4 is a flowchart illustrating an operation when video information registered in a storage means is to be deleted.

FIG. 5 is a flowchart illustrating access-count-responsive deletion processing.

FIG. 6 is a block diagram illustrating a configuration example of an electronic data inspection system of a second example embodiment of the present invention.

### EXAMPLE EMBODIMENT

### First Example Embodiment

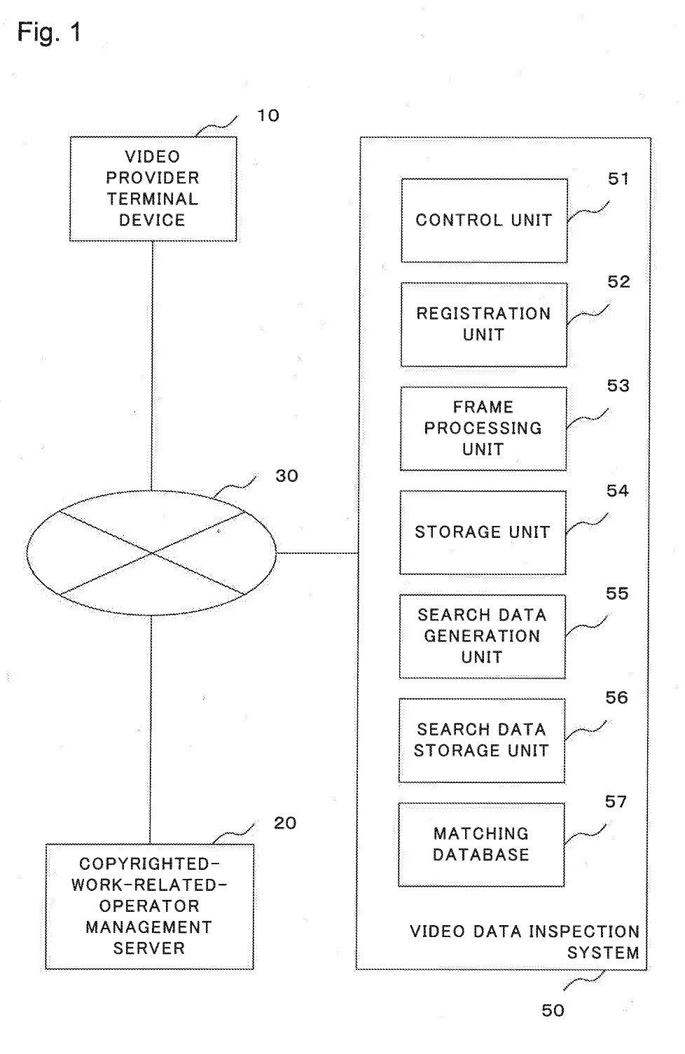

A video data inspection system of a first example embodiment of the present invention will be described with reference to drawings. FIG. 1 is a block diagram illustrating a configuration example of a video data inspection system 50 of the first example embodiment of the present invention. As illustrated in FIG. 1, the video data inspection system 50 of the first example embodiment of the present invention is connected to a communication network 30.

In addition, a video provider terminal device 10 and a copyrighted-work-related-operator management server 20 are connected to the communication network 30. Thus, the video data inspection system 50 of the first example embodiment of the present invention is disposed in such a way that the video data inspection system 50 is able to send and receive information between the video provider terminal device 10 and the copyrighted-work-related-operator management server 20.

As illustrated in FIG. 1, the video data inspection system 50 of the first example embodiment of the present invention includes a control unit 51, a registration unit 52, a frame processing unit 53, a storage unit 54, a search data generation unit 55, a search data storage unit 56, and a matching database 57.

The video data inspection system 50 is implemented, for example, by a computer including a central processing unit (CPU) and one or more circuits that execute processes under the control of a program. More specifically, the control unit 51, the registration unit 52, the frame processing unit 53, and the search data generation unit 55 are implemented by a CPU, for example. The storage unit 54, the search data storage unit 56 and the matching database 57 are implemented by a storage medium such as a hard disk, for example.

The registration unit 52 registers video information including video data sent from the video provider terminal device 10 into a storage means (not depicted). Note that, video information includes, for example, video data according to a video, text data representing the title and the like of the video, and contact information of the uploader who manages the video provider terminal device 10. Note that, the contact information of the uploader is, for example, an e-mail address of the uploader.

The frame processing unit 53 extracts a frame image based on video data provided from the copyrighted-work-related-operator management server 20. The storage unit 54 stores results of processing by the control unit 51.

The search data generation unit 55 performs processing for generating search data which is data for searching a video, based on a frame image extracted by the frame processing unit 53. Search data includes, but not limited to, numerical data such as a feature quantity in a key frame, text data such as the name (i.e. title) of a video that is based on video data, and image data such as a thumbnail image, for example.

In the search data storage unit 56, at least some of search data generated by the search data generation unit 55 is stored. The matching database 57 stores the rest of the search data generated by the search data generation unit 55.

The control unit 51 controls operations of components of the video data inspection system 50.

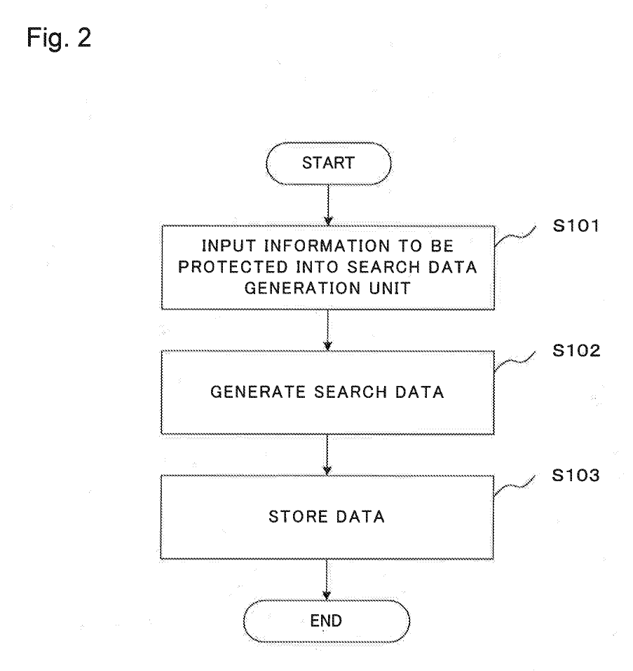

An operation of the video data inspection system 50 of the first example embodiment of the present invention will be described next. Processing for generating search data will be described first. FIG. 2 is a flowchart illustrating the operation of the video data inspection system 50 of the first example embodiment of the present invention for generating search data.

As illustrated in FIG. 2, when information to be protected, which is information according to a video to be protected, is provided from the copyrighted-work-related-operator management server 20, the control unit 51 inputs the information to be protected into the search data generation unit 55 (step S101).

The information to be protected is, for example, information according to a video to be protected under copyright law or the like and includes one or more of text data according to the title, video data, image data such as a thumbnail image and the like of the video to be protected.

Based on the information to be protected input by the control unit 51, the search data generation unit 55 generates search data (step S102).

Specifically, when the information to be protected includes video data but does not include image data, for example, the search data generation unit 55 inputs the video data into the frame processing unit 53. Then, the frame processing unit 53 extracts a frame image from the video data. The search data generation unit 55 generates image data based on the frame image extracted by the frame processing unit 53.

Further, when information to be protected includes video data but does not include text data, for example, the search data generation unit 55 inputs the video data into the frame processing unit 53. Then, the frame processing unit 53 performs speech recognition processing on the video data and extracts a character string according to the result of the processing. The search data generation unit 55 generates text data based on the character string extracted by the frame processing unit 53.

The control unit 51 stores the search data generated by the search data generation unit 55 in the processing in step S 102 and the data included in the information to be protected into the storage unit 54 and the matching database 57 (step S103).

Specifically, the control unit 51 lists text data according to the video and stores the listed text data in the storage unit 54, for example. Further, the control unit 51 stores, for example, numerical data, image data and video data according to the video into the matching database 57. Note that, in the present example, while the text data, the numerical data, the image data and the video data according to the video are stored in one of the storage unit 54 and the matching database 57, these pieces of data may be stored in the other or both of the storage unit 54 and the matching database 57. Further, the pieces of data stored in the storage unit 54 and the matching database 57 are illustrative only and other data may be stored in at least one of the storage unit 54 and the matching database 57.

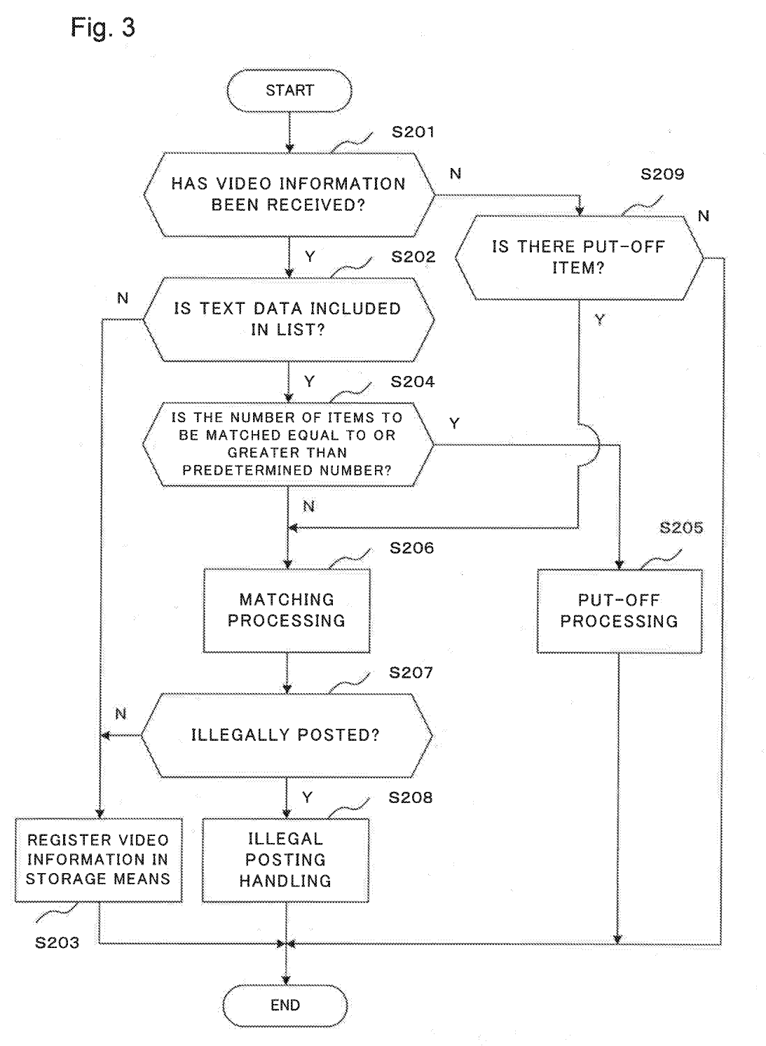

An operation of the video data inspection system 50 when the video data inspection system 50 has received video data sent from the video provider terminal device 10 will be described next. FIG. 3 is a flowchart illustrating the operation of the video data inspection system 50 when the video data inspection system 50 has received video data sent from the video provider terminal device 10.

When video information sent from the video provider terminal device 10 has been received (Y at step S201), the control unit 51 determines whether or not text data that matches text data included in the video information is in a list stored in the storage unit 54 (step S202). Note that, determination is made as to whether or not the pieces of text data match each other in the processing in step S202. This processing has a lighter processing load than the processing load of determination as to whether pieces of video data or the like match each other as in matching processing which will be described later.

When the control unit 51 determines that text data that matches the text data included in the video information is not in the list stored in the storage unit 54 (N at step S202), the control unit 51 registers the video information in the storage means (step S203). Then, the video information is delivered in response to a request from a viewer. Note that, for deletion processing, which will be described later, video information preferably includes timestamp information indicating the date and time of registration of the video information in the storage means. Further, a delivery counter that counts the number of deliveries of each piece of video information is preferably provided for the deletion processing, which will be described later.

When the control unit 51 determines that text data that matches the text data included in the video information is in the list stored in the storage unit 54 (Y at step S202), the control unit 51 determines whether or not the number of items waiting for matching processing, which will be described later, is equal to or greater than a predetermined number (step S204).

Specifically, the control unit 51 determines whether or not a value of an item counter that counts the items waiting for the matching processing is equal to or greater than a predetermined number (for example 100).

When the control unit 51 determines, in the processing in step S204, that the number of items waiting for the matching processing, which will be described later, is equal to or greater than the predetermined number (Y at step S204), the control unit 51 performs predetermined put-off processing (step S205), adds 1 to the value of the item counter, and then ends the processing.

Note that, the predetermined put-off processing is processing in which the control unit 51 stores video information in a predetermined folder or directory in the storage means, for example. The video information stored in the predetermined folder or directory in the predetermined put-off processing is then retrieved in processing, which will be described later.

When the control unit 51 determines, in the processing in step S204, that the number of items waiting for the matching processing, which will be described later, is smaller than the predetermined number (N at step

S204), the control unit 51 performs matching processing for determining whether or not data that matches the content of the video information is stored in the matching database 57 (step S206) and decrements the value of the item counter by 1.

Specifically, in the processing in step S206, the control unit 51 performs matching processing for determining whether or not data that matches the video data included in the video information is stored in the matching database 57, for example. More specifically, the control unit 51 performs matching processing for determining whether or not video data that matches the video data included in the video information is stored in the matching database 57, for example. Further, the control unit 51 generates numerical data based on the video data included in the video information, for example, and performs matching processing for determining whether or not numerical data that matches the numerical data is stored in the matching database 57. The control unit 51 generates image data based on the video data included in the video information, for example, and performs matching processing for determining whether or not image data that matches the image data is stored in the matching database 57. Note that generation of numerical data and image data based on the video data may be performed by the frame processing unit 53 and the search data generation unit 55. Further, the matching processing is performed on pieces of video information in chronological order of posting, for example.

Based on the result of the matching processing in step S206, the control unit 51 determines whether or not the video information received in the processing in step S201 has been illegally posted (step S207). Specifically, when the control unit 51 determines in the matching processing in step S206 that data that matches the content of the video information is stored in the matching database 57, the control unit 51 determines that the video information has been illegally posted (Y at step S207) and proceeds to processing in step S208. Then, the video information is delivered in response to a request from a viewer. Further, when the control unit 51 determines in the matching processing in step S206 that data that matches the content of the video information is not stored in the matching database 57, the control unit 51 determines that the video information has not been illegally posted (N at step S207) and proceeds to the processing in step S203.

Thus, determination is made as to whether or not the video information has been illegally posted in the processing in step S207, based on the result of the matching processing in step S206, which is more accurate than the processing in step S202.

In processing in step S208, the control unit 51 performs predetermined illegal posting handling (step S208). Specifically, in the processing in step S208, the control unit 51 reports to the copyrighted-work-related-operator management server 20 that the video information has been illegally posted. Note that, for example, report of the illegal posting of the video information is made by the control unit 51 sending a predetermined e-mail to a predetermined e-mail address at which the copyrighted-work-related-operator management server 20 can receive the e-mail.

Further, the control unit 51 sends an e-mail for providing a warning about the illegal posting to an e-mail address of the uploader included in the video information, for example, in the processing in step S208.

When the control unit 51 determines, in the processing in step S201, that video information sent from the video provider terminal device 10 has not been received (N at step S201), the control unit 51 proceeds to the processing in step S206 when there is video information that has been stored in the predetermined folder or directory in the storage means in the predetermined put-off processing in step S205 (Y at step S209); otherwise (N at step S209), the control unit 51 ends the processing.

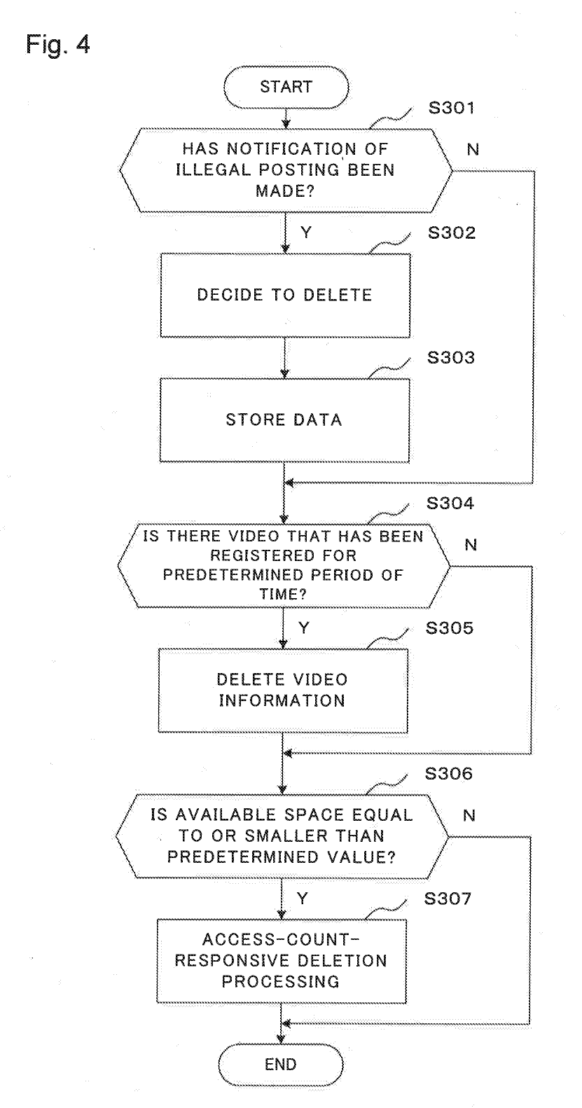

An operation for deleting video information registered in the storage means in the processing in step S203 will be described next. FIG. 4 is a flowchart illustrating the operation for deleting video information registered in the storage means.

When the control unit 51 is notified from the copyrighted-work-related-operator management server 20 that video information registered in the storage means has been illegally posted (Y at step S301), the control unit 51 determines to delete the video information from the storage means in response to the notification (step S302); otherwise (N at step S301), the control unit 51 proceeds to processing in step S304.

Note that, notification of illegal posting is made by, for example, the copyrighted-work-related-operator management server 20 sending an e-mail address including information indicating the illegally posted video information to an e-mail address at which the video data inspection system 50 is able to receive the e-mail.

Then, based on the video information determined to be deleted in the processing in step S302, data to be used in the determination in the processing in step S202 and data to be used in the determination in the processing in step S206 are generated.

Specifically, the control unit 51 performs generation processing similar to the processing in step S102, for example. Further, generation processing for extracting and generating text data from the video information is performed.

The control unit 51 stores the generated data into the storage unit 54 and the matching database 57 (step S303). Specifically, in the processing in step S303, the control unit 51 lists the text data among the pieces of data generated in the generation processing described above and stores the list in the storage unit 54 as in the processing in step S103. In addition, the control unit 51 stores, for example, numerical data, image data and video data according to the video into the matching database 57. Note that, in the present example, while the text data, the numerical data, the image data and the video data according to the video are stored in one of the storage unit 54 and the matching database 57, these pieces of data may be stored in the other or both of the storage unit 54 and the matching database 57. Further, the pieces of data stored in the storage unit 54 and the matching database 57 are illustrative only and other data may be stored in at least one of the storage unit 54 and the matching database 57.

The control unit 51 then deletes the video information determined to be deleted in the processing in step S302 from the storage means and proceeds to processing in step S304.

In the processing in step S304, the control unit 51 determines whether or not there is video information that has been registered in the storage means for a predetermined period of time among the pieces of video information registered in the storage means, based on date and time indicated by timestamp information and the current date and time (step S304). While it is assumed in the present example that the predetermined period of time is one year, for example, the predetermined period of time may be shorter or longer than one year.

When there is, among pieces of video information registered in the storage means, video information that has been registered in the storage means for a predetermined period of time (Y at step S304), the control unit 51 deletes the video information (step S305).

Further, when the available space in the storage means is equal to or smaller than a predetermined value (Y at step S306), the control unit 51 performs access-count-responsive deletion processing (step S307), and then ends the processing.

Note that, it is assumed in the present example that the predetermined value is 20% of the storage capacity of the storage means, the predetermined value may be greater or smaller than 20%.

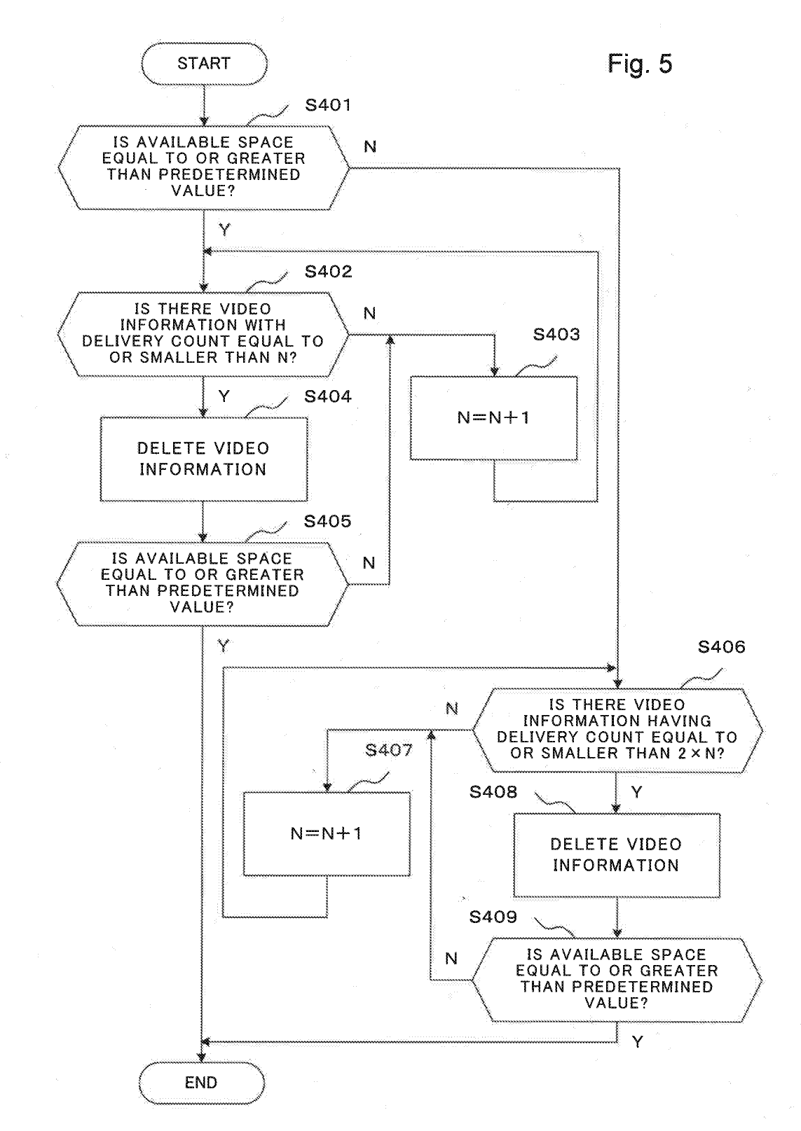

Access-count-responsive deletion processing will be described. FIG. 5 is a flowchart illustrating the access-count-responsive deletion processing.

The control unit 51 determines whether or not the available space in the storage means is equal to or greater than a predetermined value (step S401). Note that, while it is assumed in the present example that the predetermined value is 5% of the storage capacity of the storage means, the predetermined value may be greater or smaller than 5%, provided that the value is smaller than the predetermined value.

When the available space in the storage means is equal to or greater than the predetermined value (Y at step S401), the control unit 51 proceeds to processing in step S402; otherwise (N at step S401), the control unit 51 proceeds to processing in step S406.

The control unit 51 then determines whether or not video information for which the delivery counter indicating the number of deliveries has a value equal to or smaller than N is stored in the storage means (step S402). When video information for which the delivery counter indicating the number of deliveries has a value equal to or smaller than N is not stored in the storage means (N at step S402), the control unit 51 adds 1 to the value of N (step S403) and then proceeds to the processing in step S402.

When video information for which the delivery counter indicating the number of deliveries has a value equal to or smaller than N is stored in the storage means (Y at step S402), the control unit 51 deletes the video information from the storage means (step S404).

When the available space in the storage means is equal to or greater than the predetermined value (Y at step S405), the control unit 51 ends the access-count-responsive deletion processing; otherwise (N at step S405), the control unit 51 proceeds to the processing in step S403.

The control unit 51 determines, in the processing in step S406, whether or not video information for which the delivery counter indicating the number of deliveries has a value equal to or smaller than 2×N is stored in the storage means (step S406). Note that, while the determination is made as to whether or not the delivery counter has a value equal to or smaller than 2×N in the processing in step S406 in the present example, the criterion value does not necessarily need to be 2×N, provided that the criterion value is greater than N.

When video information for which the delivery counter indicating the number of deliveries has a value equal to or smaller than 2×N is not stored in the storage means (N at step S406), the control unit 51 adds 1 to the value of N (step S407), and then proceeds to the processing in step S406.

When video information for which the delivery counter indicating the number of deliveries has a value equal to or smaller than 2×N is stored in the storage means (Y at step S406), the control unit 51 deletes the video information from the storage means (step S408).

Then, when the available space in the storage means is equal to or greater than the predetermined value (Y at step S409), the control unit 51 ends the access-count-responsive deletion processing; otherwise (N at step S409), the control unit 51 proceeds to the processing in step S407.

According to the present example embodiment, when video information is posted, a determination processing which has a relatively light processing load on the video data inspection system 50 is performed in the processing in step S202 to determine whether or not the video information is suspected to have been illegally posted. Then, when the video information is determined to be suspected to have been illegally posted, determination is made as to whether or not the video information has been illegally posted in the processing in step S206, which is matching processing being more accurate determination processing than the processing in step S202.

Further, a determination processing that has a relatively light processing load on the video provider terminal device 10 is performed and video information that is not suspected to have been illegally posted among pieces of posted video information is stored in the storage means without performing the more accurate determination processing in step S205. Accordingly, increase in the processing load on the video provider terminal device 10 can be well suppressed while appropriate inspection of posted video information is performed.

Further, video information that is not suspected to have been illegally posted among pieces of posted video information is registered in the processing in step S203 without waiting for completion of the determination processing for previously posted video information in step S205. Accordingly, registration processing of video information that is not suspected to have been illegally posted among pieces of posted video information can be quickly accomplished.

Further, video information that is determined to be suspected to have been illegally posted among pieces of posted video information in the determination processing which has a relatively light processing load on the video provider terminal device 10 is not delivered until the matching processing which is more accurate determination processing is completed.

Therefore, delivery of problematic video information can be prevented.

Further, according to the present example embodiment, video information for which notification of illegal posting has been made and video information that has been registered for a predetermined period of time are deleted.

Accordingly, a space for storing new video information can be provided in advance in the storage means.

Further, according to the present example embodiment, when the available space in the storage means becomes equal to or smaller than a predetermined value, pieces of video information are deleted in ascending order of the number of deliveries until the available space becomes equal to or greater than the predetermined value.

Accordingly, when the available space in the storage means runs low, space for storing new video information in the storage means can be provided in advance by increasing the available space.

Further, according to the present invention, determination processing is performed as to whether or not video information is illegally posted video information, based on data provided by the copyrighted-work-related-operator management server 20. Then, when it is determined in the determination processing that the video information is illegally posted information, the copyrighted-work-related-operator management server 20 is reported accordingly.

Therefore, report that the video information has been illegally posted can be made to the copyrighted-work-related-operator management server 20, based on data provided by the copyrighted-work-related-operator management server 20.

Note that, while an example has been described in which video information including video data is posted, information that is posted and for which determination is made as to whether or not the information has been illegally posted is not limited to such video information. Such information may be information that includes electronic data, such as audio information including audio data or image information that includes still-image data.

### Second Example Embodiment

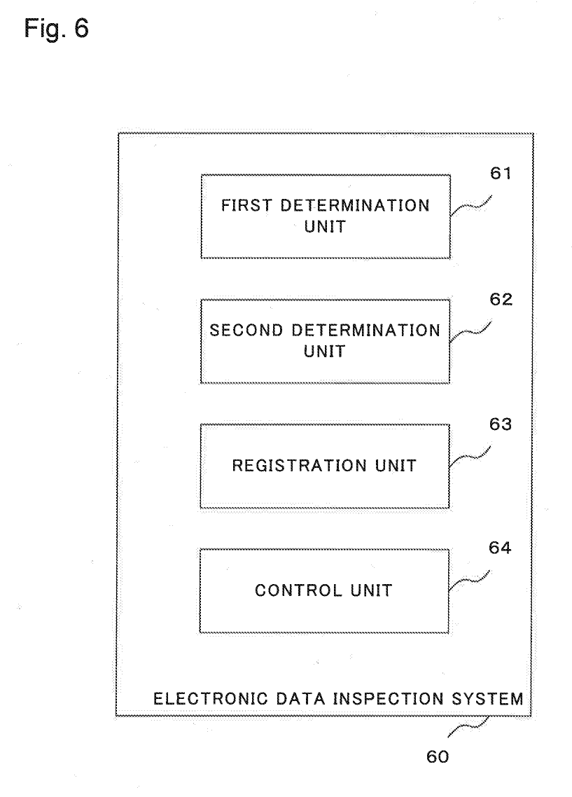

An electronic data inspection system 60 of a second example embodiment of the present invention will be described next. FIG. 6 is a block diagram illustrating a configuration example of the electronic data inspection system 60 of the second example embodiment of the present invention. As illustrated in FIG. 6, the electronic data inspection system 60 of the second example embodiment of the present invention includes a first determination unit 61, a second determination unit 62, a registration unit 63 and a control unit 64.

The first determination unit 61, the second determination unit 62, and the control unit 64 are equivalent to, for example, the control unit 51 in the first example embodiment illustrated in FIG. 1. Further, the registration unit 63 is equivalent to, for example, the registration unit 52 in the first example embodiment illustrated in FIG. 1.

The first determination unit 61 determines whether or not electronic data is illegally posted electronic data.

The second determination unit 62 determines, with higher accuracy than the first determination unit 61, whether or not electronic data determined to be illegally posted electronic data by the first determination unit 61 is illegally posted electronic data.

The registration unit 63 stores electronic data in the storage means in a deliverable manner when the first determination unit 61 or the second determination unit 62 determines that the electronic data is not illegally posted electronic data.

In accordance with on the number of pieces of electronic data that have been determined by the first determination unit 61 to have been illegally posted and are waiting for determination by the second determination unit 62, the control unit 64 causes the first determination unit 61 to perform determination processing for other pieces of posted electronic data in order prior to the determination processing for the electronic data by the second determination unit 62.

According to the present example embodiment, determination is made by the second determination unit 62 as to whether or not electronic data determined by the first determination unit 61 to have been illegally posted has been illegally posted, with higher accuracy than the first determination unit 61.

Accordingly, since electronic data that is not suspected to have been illegally posted among pieces of posted electronic data is subjected to the determination processing by the first determination unit 61, which has a relatively light processing load, and is not subjected to the determination processing by the second determination unit 62, which has higher accuracy, increase in the processing load can be well suppressed.

In addition, electronic data that has been determined by the first determination unit 61 not to be illegally posted electronic data among pieces of posted electronic data is stored in the storage means in a deliverable manner, without waiting for completion of the determination processing for previously posted electronic data by the second determination unit 62. Accordingly, registration processing of electronic data that is not suspected to have been illegally posted among pieces of posted electronic data can be quickly performed.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-51052, filed on Mar. 15, 2016, the disclosure of which is incorporated herein in its entirety by reference.

### REFERENCE SIGNS LIST

10 Video provider terminal device
20 Copyrighted-work-related-operator management server
30 Communication network
50 Video data inspection system
51 Control unit
52 Registration unit
53 Frame processing unit
54 Storage unit
55 Search data generation unit
56 Search data storage unit
57 Matching database
60 Electronic data inspection system
61 First determination unit
62 Second determination unit
63 Registration unit
64 Control unit

1. An electronic data inspection system comprising:
a first determination unit configured to determine whether or not electronic data is illegally posted electronic data;
a second determination unit configured to determine whether or not the electronic data determined to be illegally posted electronic data by the first determination unit is illegally posted electronic data, with higher accuracy than the first determination unit;
a registration unit configured to store the electronic data into storage unit in a deliverable manner when the first determination unit or the second determination unit determines that the electronic data is not illegally posted electronic data; and
a control unit configured to cause the first determination unit, prior to determination processing for the electronic data by the second determination unit, to perform determination processing for other pieces of posted electronic data in order, depending on a number of pieces of electronic data that are determined by the first determination unit to be illegally posted and wait for determination by the second determination unit.

2. The electronic data inspection system according to claim 1, further comprising determination data generation unit configured to, based on posted electronic data, generate data used for determination in the first determination unit or the second determination unit.

3. The electronic data inspection system according to claim 1, further comprising a delivery-count-responsive deletion unit configured to delete electronic data stored in the storage unit depending on a number of deliveries when available space in the storage unit is equal to or smaller than a predetermined value.

4. The electronic data inspection system according to claim 1, further comprising notification-responsive deletion unit configured to, based on notification indicating illegally posted electronic data, delete the electronic data stored in the storage unit.

5. The electronic data inspection system according to claim 1, further comprising a time-period-responsive deletion unit configured to delete the electronic data stored in the storage unit, based on a period of time that elapses after storage of the electronic data in the storing unit.

6. The electronic data inspection system according to claim 1, further comprising a reporting unit configured to, when the first determination unit or the second determination unit determines that electronic data is illegally posted electronic data, reporting to a predetermined contact point that the electronic data is illegally posted.

7. An electronic data inspection method comprising:
making first determination as to whether or not electronic data is illegally posted electronic data;
making second determination as to whether or not the electronic data determined to be illegally posted electronic data in the first determination is illegally posted electronic data, with higher accuracy than the first determination;
storing the electronic data in storage unit in a deliverable manner when the electronic data is determined not to be illegally posted electronic data in the first determination or the second determination; and
prior to determination processing for the electronic data by the second determination, causing determination processing for other pieces of posted electronic data to be performed in order in the first determination, depending on a number of pieces of electronic data that are determined to be illegally posted in the first determination and wait for determination by the second determination.

8. A non-transitory storage medium in which an electronic data inspection program is stored, the electronic data inspection program causing a computer to execute:
first determination processing of determining whether or not electronic data is illegally posted electronic data;
second determination processing of determining whether or not the electronic data determined to be illegally posted electronic data in the first determination processing is illegally posted electronic data, with higher accuracy than the first determination processing; and
registration processing of storing the electronic data in storage unit in a deliverable manner when the electronic data is determined not to be illegally posted electronic data in the first determination processing or the second determination processing, and to perform,
prior to the second determination processing for the electronic data, the first determination processing for pieces of other posted electronic data in order, depending on a number of pieces of electronic data that are determined to be illegally posted in the first determination processing and wait for determination by the second determination processing.
